(19) United States
(12) Patent Application Publication
(10) Pub. No.: US 2007/0124396 A1
(43) Pub. Date: May 31, 2007

(54) ELECTRONIC MAILING METHOD, SYSTEM AND COMPUTER PROGRAM

(76) Inventors: Barbara Febonio, Roma (IT); Sandro Piccinini, Roma (IT)

Correspondence Address: IBM CORPORATION;INTELLECTUAL PROPERTY LAW, 11400 BURNET ROAD, AUSTIN, TX, 78758, US

(21) Appl. No.: 11/558,678

(22) Filed: Nov. 10, 2006

(30) Foreign Application Priority Data
Nov. 25, 2005 (EP) 05111326.4

(51) Int. Cl. G06F 15/173

(52) U.S. Cl. 709/206; 709/224

(57) ABSTRACT

An electronic mailing method comprises: upon sending an electronic mail message to a recipient, activating an automatic monitoring of the receipt of a reply message to the message, said automatic monitoring comprising: ascertaining whether the reply to the message has been received, and in the negative case, alerting at least one among a sender of the message and the recipient of the message, for example sending a reminder message to the recipient adapted to remind him/her to send the reply message.

### TECHNICAL FIELD

The present invention generally relates to the field of electronic data processing and data communications systems, and particularly to data processing system networks (shortly, computer networks) supporting electronic messaging (hereinafter referred to as electronic mail, or, shortly, e-mail) systems.

### BACKGROUND ART

With the growth of computer networks, e-mail has become an extremely fast, economic, easy to use and thus extremely popular interpersonal communication means, for both private and professional purposes. In particular, thanks to the impressive diffusion of the Internet in the past fifteen years, Internet Protocol (IP) e-mail nowadays provides a standard communication mechanism for millions of computer users. Nomadicity and the advent of wireless networks, together with the addition of packet-switched capabilities to mobile telephony networks have further increased the popularity of e-mail as a communication resource.

Generally speaking, by means of any one of the several, commercially available e-mail client software tools, designed to be installed and executed on personal computers, workstations, portable computers, smart mobile phones, such as IBM Lotusnotes, Microsoft Outlook or Outlook Express, Eudora, Mozilla Thunderbird, just to cite few examples, the management of e-mail messages, particularly activities like receiving, displaying, archiving, composing and sending an e-mail message, is a rather simple task. For example, receiving an e-mail message is as simple as clicking a button on the computer screen using the mouse (after having done the proper settings, and provided a connection to a data communications network is established); composing and sending an e-mail message is easy as well, and involves specifying the e-mail address or addresses of one or more intended recipients of the message (typing it/them in or retrieving it/them from an address book containing user-defined e-mail addresses) in one or more recipient address fields of a message composition dialog window displayed on the computer screen, editing if desired a message subject field, editing a message body and, possibly, attaching one or more files to the message.

Roughly speaking, an e-mail system is conventionally composed by two kinds of sub-systems, cooperating with each other.

In detail, the e-mail clients, also referred to as Mail User Agents (MUAs), running on the users' data processing apparatuses (personal computers, workstations, personal digital assistants, smart mobile phones and the like) of users which are subscriber of the e-mail service and enabling these users to handle (compose, send, receive, display) e-mail messages, form a first type of sub-system.

A second type of sub-system includes so-called Mail Transport Agents (MTAs); the MTAs act as bridges between different hosts, wherein the mailboxes of the users reside. Typically, an MTA includes a Simple Mail Transfer Protocol (SMTP) server, handling the reception of messages from the MUAs of the sender users, and the delivery/the reception of e-mail messages to/from other SMTP servers.

The MTA further includes a so-called Mail Delivery Agent (MDA), which is used by the MTA for delivering received e-mail messages to the mailbox(es) of the intended recipient(s). The e-mail messages received by the MTA and addressed to a generic user are at least temporarily stored by the MUA in that user's mailbox. Typically, the MDAs include a Post Office Protocol (POP) server, e.g., a POP3 server, allowing the users to access the respective mailboxes from their data processing apparatuses via the MUAs running thereon.

Most of the commercially available MUAs implement several features that make the process of preparing and sending an e-mail message easy; most of the MUAs also allow setting priority levels for a message to be sent, thereby the message, when received by the intended recipient user's MUA, is for example displayed in some highlighted form, and to set a receipt acknowledgment request, according to which the message recipient, for example upon displaying the message, is asked to send to the message sender a confirmation that the message has been received.

### SUMMARY OF THE INVENTION

The Applicant has observed that, as normally occurs in more traditional forms of human-to-human communication, a user that sends an e-mail message to a certain recipient, may in some cases expect a reply from the message recipient (s). In particular, the reply may be expected within a target date; for example, the requested reply message may have to include instructions for performing some sort of activity.

As far as the Applicant is aware, the commercially known MUAs have no function that is adapted to assist the message sender user in the task of verifying whether the expected reply message has been received from the message recipient. Thus, the burden of ascertaining whether the desired response has been received, particularly when a time limit set for the reply approaches, is completely on the sender user, who may waste precious time to repeatedly check, every now and then, the incoming mail (connecting to his/her mailbox and downloading the newly received messages) in order to see whether the expected response has been received, and, possibly, sending one or more reminder messages; the risk also exists that the user forget to control whether the reply has been received, and/or to send the reminder, or that he/she remembers to do it when is too late, with the undesirable consequence that a certain, maybe important action is not performed in due time.

The Applicant has thus observed that there is the need to improve the bouquet of features of the currently available MUAs, so as to alleviate the users from the burden of performing tasks like those mentioned above.

In view of the foregoing, the Applicant has tackled the problem of improving and enriching the features of known MUAs, particularly in order to avoid that a user has to personally take care of situations like the one described above.

According to a first aspect of the present invention, an electronic mailing method as set forth in the appended claim. The method comprises:
upon sending an electronic mail message to a recipient, activating an automatic monitoring of the receipt of a reply message to the sent message, said automatic monitoring comprising:
ascertaining whether the reply to the message has been received, and
in the negative case, automatically alerting at least one among a sender of the message and the recipient of the message.

In particular, in an embodiment of the present invention, said automatically alerting includes automatically sending a reminder message to the recipient adapted to remind him/her to send the reply message.

In particular, in an embodiment of the present invention, while activating the automatic monitoring, a target reply date may be set, either by default (e.g., in terms of a predetermined number of days from the day the message is being sent), or defined by the message sender, whereby when it is ascertained that the expected reply message is not received by the target date, or by a date sufficiently in advance from the target date (how much in advance may be set by default, or defined by the user), the reminder message is set. Also, in an embodiment of the present invention, the reminder message may be sent twice or more, according for example to a repetition rate that may be set by default or defined by the user while activating the automatic monitoring.

Other aspects of the present invention relate to a system comprising means adapted to carry out the steps of the method, and to a computer program comprising instructions for carrying out the steps of the method when said computer program is executed on a computer.

### BRIEF DESCRIPTION OF THE DRAWINGS

The features and advantages of the present invention will be made apparent by the following detailed description of an embodiment thereof, provided merely by way of non-limitative example, description which will be made in conjunction with the attached drawing sheets, wherein:

FIG. 1 is a schematic, very simplified view of a computer network supporting an e-mail service;

FIG. 2 schematically shows, in terms of functional blocks, the main components of a generic computer of the network of FIG. 1;

FIG. 3 schematically shows, in terms of functional blocks, a partial content of a working memory of a computer of the network of FIG. 1, when executing an e-mail client software tool adapted to implement a method according to an embodiment of the present invention; and

FIG. 4 is a schematic flowchart illustrating some of the steps of a method according to an embodiment of the present invention.

### DETAILED DESCRIPTION OF THE PREFERRED EMBODIMENT

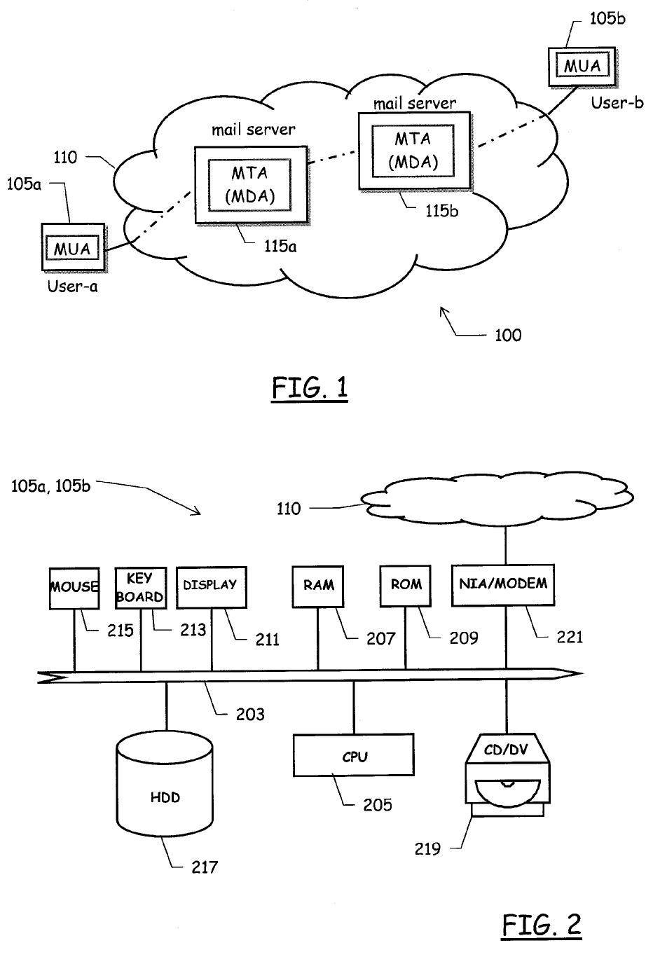

With reference to the drawings, in FIG. 1 a distributed electronic data processing system or, shortly, computer network 100 is shown very schematically. The computer network 100 is intentionally depicted at a high level, so that it can be intended to be representative of the most diverse computer networks; it can be for example a Local Area Network (LAN), a Metropolitan Area Network (MAN), a Wide Area Network (WAN) or a network of networks such as the Internet, it can be or include one or more wired or a wireless network, particularly but not limitatively a mobile telephony network like a GSM (General System for Mobile communications) network (or counterpart standards), or a UMTS (Universal Mobile Telecommunications System) network (or equivalent standards) with GPRS (General Packet Radio System) infrastructure.

A plurality of data processing apparatuses, e.g., Personal Computers (PCs), workstations, personal digital assistants, smart mobile phones or the like, such as the two exemplary data processing apparatuses 105a and 105b shown in the drawing, are connected (through respective, suitable network access points, not explicitly depicted in the drawing) to a data communication infrastructure 110, intended to schematically represent any possible data communication infrastructure like a wired or a wireless infrastructure, or a combination thereof, so that the various data processing apparatuses are interconnected/interconnectable to each other.

In the following of the present description, just for the sake of conciseness and without for this reason limiting the present invention, the two data processing apparatuses 105a and 105b will be shortly referred to as computers, of two generic users “user-a” and “user-b”.

The generic computer 105a, 105b may in principle be represented in the way schematically shown in FIG. 2, with several functional units connected in parallel to a data communication (e.g., a PCI) bus 203. In particular, a Central Processing Unit (CPU) 205, typically comprising a microprocessor (possibly, a plurality of cooperating microprocessors), controls the operation of the computer, a working memory 207, typically a RAM (Random Access Memory) is directly exploited by the CPU 205 for the execution of programs and for the temporary storage of data during program execution, and a Read Only Memory (ROM) 209 is used for the non-volatile storage of data, and stores for example a basic program for the bootstrap of the computer, as well as other data. The computer comprises several peripheral units, connected to the bus 203 by means of respective interfaces. Particularly, peripheral units that allow the interaction with a human user are provided, such as a display device 211 (for example a CRT, an LCD or a plasma monitor), a keyboard 213 and a pointing device 215 (for example a mouse). The computer also includes peripheral units for local mass-storage of programs (operating system, application programs) and data, such as one or more magnetic Hard-Disk Drivers (HDD), globally indicated as 217, driving magnetic hard disks, a CD-ROM/DVD driver 219, or a CD-ROM/DVD juke-box, for reading/writing CD-ROMs/DVDs. Other peripheral units may be present, such as a floppy-disk driver for reading/writing floppy disks, a memory card reader for reading/writing memory cards, a Universal Serial Bus (USB) adapter with one or more USB (Universal Serial Bus) ports, printers and the like. For the connection to the data communication infrastructure 110, the computer may be further equipped with a Network Interface Adapter (NIA) card 221; alternatively (or in addition), the computer may be connected to the data communication infrastructure 110 by means of a MODEM, not explicitly depicted in the drawing; in the case of a mobile phone, the connection to the data communications infrastructure 110 is achieved by means of the radio transmitter/receiver provided for the connection to the mobile telephony network.

Any other data processing apparatus in the computer network 100 has a structure generally similar to that depicted in FIG. 2, possibly properly scaled depending on the machine computing power.

Referring back to FIG. 1, the computer network 100 supports an e-mail service, enabling users of computers connected to the network, such as the users user-a and user-b of the computers 105a and 105b, to exchange e-mail messages over the network 100. Each one of the computer users, like the users user-a and user-b of the computers 105a and 105b, who is a subscriber to the e-mail service is identified by a unique e-mail address; a generic e-mail address takes the known, general form:

user@host.domain,

where user is the user's account name (identifying the user's mailbox), @ is a standardized separator, and host.domain is the domain name of the host data processing apparatus managing the user's mailbox. Hereinafter, it is assumed that the users user-a and user-b of the computers 105a and 105b have respective e-mail addresses user-a@aaa.com and user-b@bbb.com.

Generally speaking, the e-mail service is supported by the provision, within the computer network 100, of mail server computers (shortly, mail servers), like the mail servers 115a and 115b, which are host computers that manage the receipt and delivery of e-mail messages to the proper recipients.

Schematically depicted in FIG. 1 are two mail servers 115a and 115b, the former being the mail server to which the user user-a has subscribed, the latter being instead the mail server of the user user-b. It is pointed out that the assumption that the two users user-a and user-b are registered to different mail servers is not to be construed as a limitation of the present invention, which applies as well in the case the users share the mail server.

As discussed in the introductory part of the present description, an e-mail system is conventionally composed by two kinds of sub-systems, cooperating with each other, namely Mail User Agents (MUAs) and Mail Transfer Agents (MTAs). MUAs are the e-mail client software tools installed and running on the computers of the users, like the computers 105a and 105b of the users user-a and user-b, who are subscriber of and wishing to exploit the e-mail service; the MUAs enable the users to manage, particularly compose, send, receive, display, archive, print etc., e-mail messages, directly from their computers. The MTAs act as bridges between different mail servers; typically, an MTA includes a Simple Mail Transfer Protocol (SMTP) server, handling the reception of messages from the MUAs of the sender users, and the delivery/the reception of e-mail messages to/from other SMTP servers, based on the prescriptions of the SMTP protocol; the SMTP standard is described in the Request For Comments (RFC) 2821 entitled “Simple Mail Transfer Protocol”, which is incorporated herein by reference. The MTAs further include so-called Mail Delivery Agents (MDAs), which are used by the MTAs for delivering received e-mail messages to the mailbox(es) of the intended recipient(s), the mailboxes being held at the mail server. The e-mail messages received by the MTA and addressed to a generic user are at least temporarily stored by the MUA in that user' mailboxes. Typically, the MDAs include a Post Office Protocol (POP) server, e.g., a POP3 server, allowing the MUAs of the subscriber users to access the respective mailboxes from their computers.

In the computers 105a and 105b of the users user-a and user-b, e-mail client software tools are assumed to be installed which, when executed, set up MUAs that enable the users managing (compose, send, receive, display, etc.) e-mail messages.

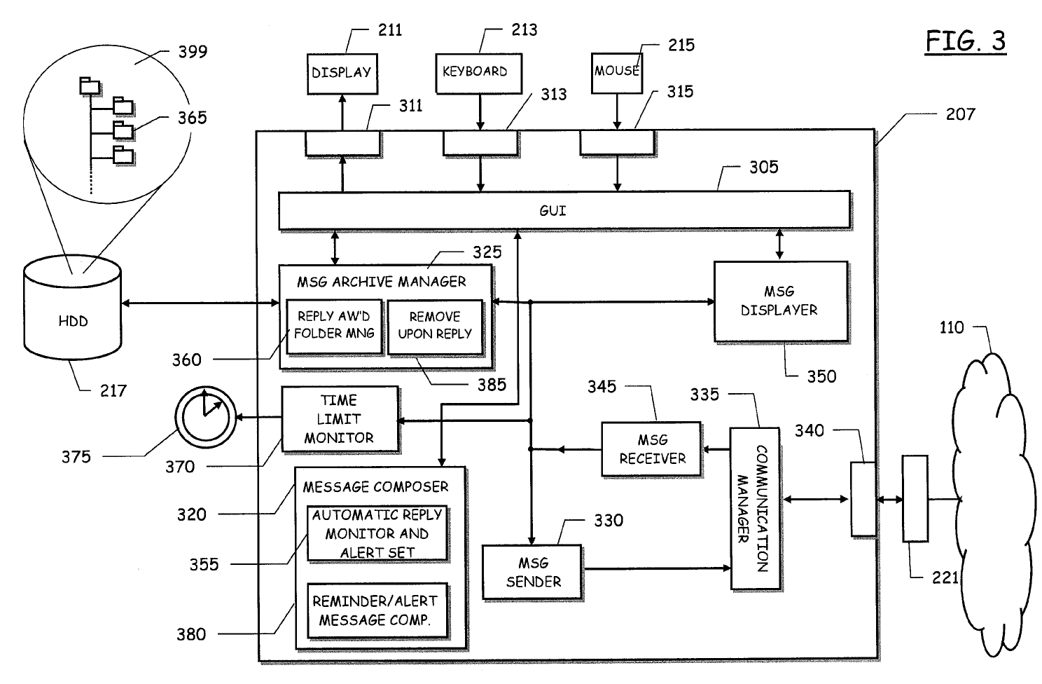

In particular, referring to FIG. 3, there is schematically depicted the partial content of the working memory 207 of the generic one of the two computers 105a and 105b, for example the computer 105a of the user user-a, which hereinafter is assumed to be the sender of an e-mail message; the user user-b is instead assumed to be the receiver of a message. When executing the e-mail client software tool, like LotusNotes, Outlook, Outlook Express, Eudora, Thunderbird, an MUA is set up in the user's computer; the MUA includes a Graphical User Interface (GUI) 305 that allows a friendly interaction of the computer user with the e-mail client software, through the display device 211 and the input devices 213 and 215; in particular, hardware-dependent software drivers 311, 313 and 315 are exploited by the GUI 305 for communicating with the peripheral devices 211, 213 and 215.

When the user wishes to compose a new e-mail message, a message composer module 320 of the MUA is invoked. The message composer module 320, interacting with the GUI 305, guides the user in the process of composing the e-mail message; in general, a message composition window is popped up on the computer's display device 211, corresponding to the new e-mail message being created; the user fills in the various message fields, like the recipient(s) address(es) field(s), the message subject field, the message body field; exploiting functions commonly available in most of the known MUAs, he/she may attach one or more files, set a desired priority level, activate a receipt acknowledgment request, and so on. The message composer module 320 also formats the new messages according to the syntax prescriptions of one of the known standards for formatting e-mail messages. An example of these standards is the RFC 822 (“Standard for the Format of ARPA Internet Text Messages”); other standards are the RFC 2822 (“Internet Message Format”, essentially an updated version of the RFC 822), the RFC 1341, the RFC 2045, the RFC 2046 and the RFC 2049; these last four standards are also called Multifunction Internet Mail Extensions, shortly MIME. All the above listed standards are incorporated herein by reference. In particular, the RFC 822 and RFC 2822 standards are aimed at specifying the format of text messages in ASCII code, while the MIME standards, which are substantially an extension of the RFC 822 and 2822 standards, also specifies the format for multimedia messages including sound, images, video.

The message composer module 320 interacts with a message archive manager module 325, managing an archive 399 of messages (stored for example in the HDD 217, and possibly is loaded into the computer working memory 207 when the MUA is launched, for faster access thereto); the message archive is for example structured in a hierarchical tree of folders and sub-folders, including in particular an “Inbox” folder, a “To be sent” folder, a “Sent” folder, a “Trash” folder, wherein the e-mail messages received (download from the mail server), to be sent, sent, deleted are stored (other folders may be provided for, as well as created by the user according to his/her own desires).

A message sender module 330 manages the sending of the e-mail messages; the message sender module 330 interacts with the message archive manager module 325, for retrieving the message(s) to be sent from the folder of the messages waiting to be sent (the To be sent folder), and with a communication manager 335, which handles the transmission of the message over the data communications infrastructure 110, by means of the network interface adapter/MODEM 221 (driven by a suitable software driver 340). The message sender module 330 also causes the message archive manager module 325 to remove the sent message(s) from the To be sent folder, and to save a copy of the sent message(s) in the Sent folder of the message archive 399, containing a copy of every message that has been sent.

A message receiver module 345 interacts with the communications manager 335 for receiving messages (coming from an MDA over the data communication infrastructure 110), and with the message archive manager module 325, for storing the received messages in the Inbox folder of the message archive 399.

A message displayer module 350 interacts with the message archive manager module 325 and with the GUI 305, for displaying on the computer display 211 selected messages in the message archive. Messages can be displayed in differentiated ways according to the fact that the message has not yet been read after having been received, and/or based on message attributes, like for example the priority level; in case a received message has an attribute specifying that the sender has requested a receipt confirmation, a pop-up window is displayed to the recipient user, asking him/her to send to the receipt acknowledgment.

The message archive manager module 325 further manages the moving of the messages stored in the message archive from one folder thereof to another, as well as the deletion of messages (moving the messages to be deleted to the Trash folder, and purging it when requested).

According to an embodiment of the present invention, a method and system are provided which allow a user, like the user user-a, when composing and sending an e-mail message to a generic message recipient, like the user user-b, to specify that a reply to the message is awaited from the recipient, possibly by a determined date, or within a determined time period, thereby, after the message has been sent, the MUA of the message sender user automatically checks for the receipt of the awaited reply message from the original message recipient and, in case the reply message is not received by the intended date (which can be the target receipt date, or optionally an alert date, or a date sufficiently in advance with respect to the target date), a reminder message is automatically generated and sent to the original message recipient so as to remind him/her that a reply is still awaited (possibly, this reminder message generation and sending is performed repeatedly, with a determined periodicity, until the reply message is received, or until a final time limit expires, or for a determined number of times).

To this purpose, according to an embodiment of the present invention, the message composer module 320 includes an automatic reply monitor and alert attribute set module 355, invoked for example upon activation by the user, while composing the message, of a specific menu option, or clicking a push-button in a message composition window. The message composer module 355 is adapted to include, in the e-mail message being composed, one or more message attributes that are in turn adapted to specify, to the MUA, that in respect of the message being composed, the MUA has to set up an automatic alert procedure for automatically monitoring the receipt of the required reply message and, in case of missing reply, issuing reminder messages.

Schematically, the message archive manager module 325 includes a reply awaited folder manager module 360 adapted to create and manage a folder 365, hereinafter referred to as “Reply awaiting”, in the message archive 399, wherein, once sent, the messages for which the automatic reply monitoring procedure is set are copied. For example, the sent messages, when removed from the To be sent folder, in addition to (or instead of) being copied into the Sent folder, are copied into the Reply awaiting folder 365.

A time limit monitor module 370 is also provided, adapted to look through the messages stored in the Reply awaiting folder 365 and to check whether the time has come to issue an alert, for example to send a reminder message to the recipient of the original message, so as to remind him/her that a reply is still awaited; the time limit monitor module 370 exploits a real time clock unit 375, for example the real time clock of the computer 105a.

According to an embodiment of the present invention, the message composer module 320 includes a reminder/alert message composer module 380, adapted to create a reminder/alert message to be sent to the original message recipient upon detection, by the time limit monitor module 370, that no reply has yet been received. The reminder/alert message may for example be a forward message of the original message, particularly of the copy thereof stored in the Reply awaiting folder 365.

The message archive manager module 325 includes a remove upon reply module 385 which is adapted to detect when an incoming message is the expected reply to one of the messages stored in the Reply awaiting folder 365, and to accordingly remove the proper message from this folder (copying the message into the Sent folder, if not done upon sending the message, or simply moving the message from the Reply awaiting into the Trash folder).

According to an embodiment of the present invention, in order to implement the automatic monitor and alert procedure, a message identifier is exploited, particularly the unique message identifier that the MUAs normally assign to the messages for univocally identifying them.

Let by way of example the RFC 822 standard be considered. This standard prescribes that an e-mail message is a text string formed by a message header portion and a message body portion, separated by a blank line. The message body portion contains the message body. The message header portion has a relatively rigid format, and consists of several fields, some of which must be present in every e-mail message. Typically, the message header portion includes a field (“From” field) specifying the e-mail address of the message sender, one or more fields for specifying the intended recipient(s) of the message (a “To” field specifies the e-mail address, or the list of e-mail addresses of the intended primary recipients; other fields allow specifying addresses of recipients that are intended to receive the message in copy), a field (“Subject” field) that contains the message subject specified by the user (if any: this field may be left void), a field (“Date” field) that contains an indication of the date (and time) the message has been sent, and possibly other fields not relevant to the present description. A field (“Message-ID” field) of the message header contains a unique message identifier adapted to uniquely identifying that message. For example, a generic message sent by the user user-a to the user user-b may be the following (the fragment is quite schematical, and many additional information included in an real message is omitted because not relevant):

From: <user-a@aaa.com>

To: <user-b@bbb.com>

Subject: Seminar Enrollment registration request

Date: Mon, 14 Nov. 2005 09:05:03-0600

Message-ID: <1234@aaa.com>

Dear User-b,

Please do not forget to enroll for the seminar starting December 1. Enrollment requests are to be received by November 25. Please reply to this message for confirmation.

According to an embodiment of the present invention, the message identifier, in the example above the string 1234@aaa.com, is advantageously exploited by the MUA of the user user-a for monitoring whether an expected reply has been received in respect of the message. For example, a reply message generated by the recipient, in the considered example the user user-b, exploiting the “Reply” function of his/her MUA, includes the message identifier of the original message, as depicted in the simplified and exemplary message fragment reported below, which is assumed to be a reply message from the user user-b to the original message reported above:

From: <user-b@bbb.com>

To: <user-a@aaa.com>

Subject: Re: Seminar Enrollment registration request

Date: Fri, 18 Nov. 2005 19:10:07-0600

Message-ID: <3456@bbb.com>

In-Reply-To: <1234@aaa.com>

References: <1234@aaa.com>

---Original message---

Dear User-b,

Please do not forget to enroll for the seminar starting December 1. Enrollment requests are to be received by November 25. Please reply to this message for confirmation.

The field “In-Reply-To”, in the message header, contains the message identifier of the original message (the standard provides for another header field, called “References”, which, in the case of a multimessage thread, contains the message identifiers of all the previous messages which have been replied to).

In an embodiment of the present invention, the MUA of the original message sender user-a is adapted to check for the message identifiers present in the field “In-Reply-To” of incoming messages so as to determine which is the original message to which the reply message refers, and thus ascertaining whether or not the received message is one of the expected replies to the messages waiting for being replied to. In particular, in an embodiment of the present invention, the remove upon reply module 325 in the message archive manager module 325 uses the message identifier present in the “In-Reply-To” field of any received message as a search key for searching messages in the Reply awaiting folder 365 and establish whether the received message is the expected reply to one of those messages. It is however pointed out that the use of the above described message identifier is not to be construed as limitative: any other way of identifying the original message to which a reply message from the original message recipient refers can be exploited, for example a custom-designed message identifier.

As known, e-mail message formatting standards like the RFC 822 allow putting in the message header portion optional, user-defined fields, that are not specified in the standard, and may be exploited for custom-designed purposes, upon condition that the nonstandard fields conform with a prescribed syntax.

According to an embodiment of the present invention, a dedicated message header field is defined and exploited for specifying that, in respect of an e-mail message being sent, the MUA has to set up the automatic reply monitoring and alerting. In particular, and just by way of example, the additional header field may be named “Reply required”, and it may be intended to include information like the date by which the reply is expected to be received, possibly in the form of a date or, alternatively, as a number (e.g., number of days) to be added to the message sending date. The presence, in a certain message, of the field “Reply required” may for example be per-se sufficient to indicate to the MUA that the message is to be handled differently than the normal messages (e.g., the module 360 of the message archive module 325 understands that the message has to be copied into the “Reply required” folder 365). In alternative embodiments of the invention, the MUA may always insert in any newly generated message the field “Reply required”, and in order to activate the automatic monitoring and alerting procedure the user has to specify parameters, so that the field has to be assigned a prescribed value (if is void the MUA understands that no automating monitoring and alerting is requested. The field “Reply required” may additionally contain a user-defined value specifying an alert/reminder message repetition rate, a maximum number of alert/reminder messages to be sent, a safeguard time interval in advance of the final expected reply date for starting sending alert/reminder messages in case of no reply received.

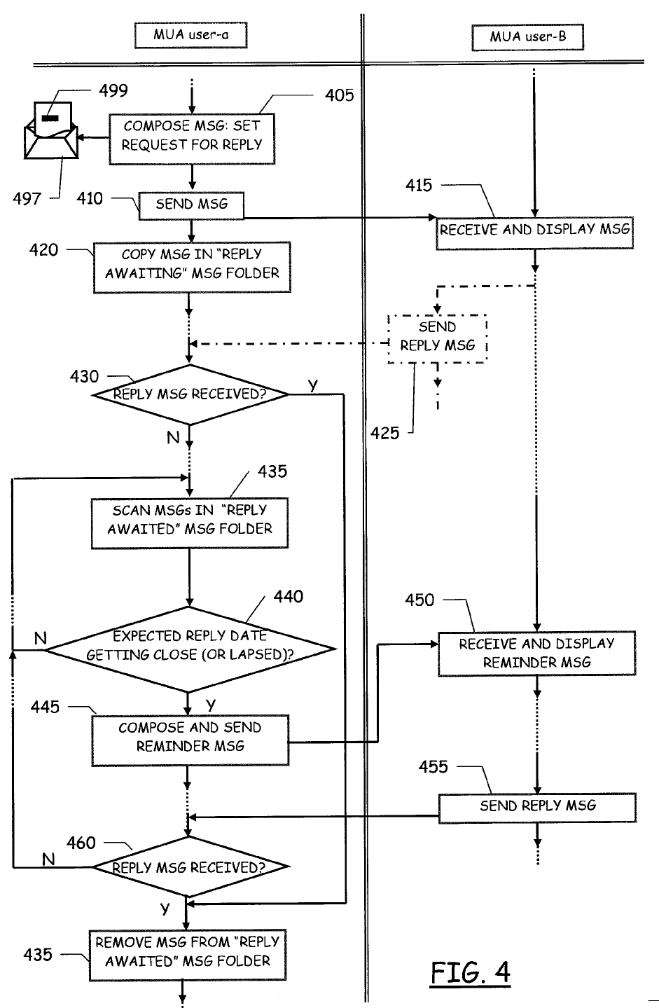

In the following, a method according to an embodiment of the present invention will be described, for the automatic monitoring of the receipt of replies to e-mail messages from a specified message recipient, and for automatically issuing reminder messages in case of no reply. Reference is made to the schematic, simplified operation flow of FIG. 4.

The user user-a of the computer 105a writes a message for the user user-b of the computer 105b (block 405), for example, the message reported in the foregoing. The composition of the message follows the same usual rules: the user user-a selects a “New message” or “Create message” menu option on his/her MUA, then he/she fills in the fields related to the intended message recipient e-mail address (in this example, the address user-b@bbb.com), the message subject, the message body, and the like; he/she may attach files, set a certain priority level for the message, and/or set a receipt acknowledgment request.

Let it be assumed that the user user-a needs or simply wishes that the user user-b replies to the message which is being sent thereto, because he/she may need information, like a confirmation or an instruction from the user user-b, and for example the reply is wished, or needed, in general expected, within a certain date (the expected reply date). According to an embodiment of the present invention, by selecting a specific menu option on the MUA, the user user-a is enabled to set, for the message being composed and which will be sent, the automatic monitoring of the reply reception by the MUA, and possibly specifying the expected reply date, either as a real date (day, month, year) or in terms of a time period (e.g., number of days) to be calculated after the date of sending of the message. It is observed that in some embodiments of the present invention, the user may be dispensed from specifying the expected reply date: the latter may be preset, for example as a user preference valid in general; also in cases like this, it may however be provided that the user may specify a different expected reply date, in this way overriding the default one.

According to an embodiment of the present invention, the MUA (particularly the message composer module 320, even more particularly the module 355) adds to the header of the message being composed 497 the custom, nonstandard field “Reply required”, schematically depicted in the drawing as 499, whose presence in the header portion of the message being composed is adapted to signal to the MUA that the message has to be treated differently from a usual message; the “Reply required” field is filled with the expected reply date, specified by the user or set by default, and, possibly, by the desired safeguard time interval, and/or the reminder message repetition rate, and/or the maximum number of reply messages to be sent.

When the editing of the message is terminated, the user user-a causes the message 497 to be sent to the intended recipient user-b (block 410).

The message is transmitted in the same way as any normal message, and is eventually received by the MUA of the user user-b, which downloads the message from his/her mailbox.

The message, once sent, is for example represented by the fragment below:

From: <user-a@aaa.com>

To: <user-b@bbb.com>

Subject: Seminar Enrollment registration request

Date: Mon, 14 Nov. 2005 09:05:03-0600

Message-ID: <1234@aaa.com>

Reply required: 25 Nov. 2005

Dear User-b,

Please do not forget to enroll for the seminar starting December 1. Enrollment requests are to be received by November 25. Please reply to this message for confirmation.

wherein the nonstandard, custom header field 499 has been highlighted.

After having been sent, the message is copied into the Reply awaiting message folder 365 (block 415), in order to be entered in the list of monitored message (i.e., the list of messages in respect of which the MUA automatically monitors the receipt of reply messages).

The user user-b receives the message and displays it (block 415), as with any other usual message. Upon reading the message, the user user-b understands that a reply from him/her is awaited, and he/she may decide send the requested reply.

Let it be assumed that, a certain time, the user user-b sends the expected reply (block 425); according to an embodiment of the present invention, the reply message includes the unique identifier of the original message, for example the reply message is generated exploiting the “Reply” feature of the MUA of the user user-b, which causes the unique identifier of the original message to be included in the “In-Reply-To” header field of the reply message. However, the user user-b may build the reply message in a different way, for example creating a normal new message, and including the identifier of the received message in the reply message body, or in the reply message subject field.

If the MUA of the user user-a receives the reply message before the expected reply date (possibly anticipated by a safeguard time interval) (decision block 430, exit branch Y), the (remove upon reply module 385 of the) message archive manager module 325, in addition to the usual actions, also checks in the Reply awaiting message folder if the received message is the expected reply to one of the messages waiting in such a folder; the search is conducted exploiting the unique message identifier that is included in the “In-Reply-To” field of the received message, and which the (remove upon reply module 385 of the) message archive manager module 325 retrieves and compares to the message identifiers of all the messages in the folder. The message whose identifier coincides with that retrieved from the “In-Reply-To” field of the received message is removed from the folder (block 435), i.e. the message is removed from the message monitoring schedule of the MUA; the removed message can for example be moved to the trash folder.

Let it be assumed now that the reply message is not received by the expected reply date (for example, in case a safeguard time interval is specified, the reply message is not received by an alert date being the expected reply date advanced of the safeguard time interval) (exit branch N of decision block 430).

Periodically, for example once a day the (time limit monitor module 370 of the) MUA of the user user-a scans the messages stored in the “Reply awaiting” folder 365, checking their expected reply date and comparing them with the current date (block 435, and decision block 440). When the MUA finds a message for which the expected reply date (as specified in the “Reply required” header field of the message) is come, or is approaching (i.e., the above-mentioned alert date has come) (exit branch Y of decision block 440), the (time limit monitor module 370 of the) MUA of the user user-a instructs the (reminder/alert message composer module 380 of the) message composer module 320 to compose and send a reminder to the user user-b (block 445). For example, the reminder message may be a forward of the original message.

The user user-b receives the reminder message, and he/she is thus reminded of the still missing reply to the previously received message (block 450).

When (and if) the user user-b sends the reply message (block 455), and the MUA of the user user-a detects in the way described above that the reply message has been received (decision block 460, exit branch Y), the original message is removed from the Reply awaiting folder (block 435), otherwise (exit branch N of decision block 460), the MUA periodically sends to the user user-b reminders, for example based on a periodicity set by the user user-a in the original message, or determined by default; the reminders may be limited to a maximum number.

Thanks to the method according to the invention embodiment described herein, a user can be alleviated from the burden of periodically checking that an expected reply to a message he/she sent to some recipient has or has not been received, and, in the latter case, sending one or more reminders. The process is automated at the level of the MUA. This translates into a non-negligible saving of time, and is also much less prone to errors, because the user might forget to check for a received reply, and to send a reminder if necessary.

The implementation of the present invention has a limited impact, and merely requires a modification to the existing e-mail client software tools. Advantageously, in only the MUA-side needs to be modified, whereas the MTA-side of the e-mail system remains unaltered. The modification may additionally take the form of a plug-in to the existing MUAs, that can be added at any time after installation, and does not require to buy and install a totally new mail client.

Although the present invention has been described by way of an embodiment, it is apparent to those skilled in the art that several modifications to the described embodiments, as well as other embodiments of the present invention are possible without departing from the scope thereof as defined in the appended claims.

For example, in some embodiments of the invention, the MUA of the recipient may be adapted to detect the presence in the received message of the “Reply required” field in the header, and to automatically ask to the user user-b to send the expected reply, in a way similar to what is done for the request of acknowledgment of receipt. Also, in alternative, the MUA of the recipient may be adapted to automatically monitor that, in respect of a generic message for which a reply is expected, the user user-b has not yet sent the reply, and, when the expected reply date comes (or approaches), to automatically remind the user that a reply still has to be sent. In particular, an alert date (sufficiently in advance of the expected reply date) may be set in the original message upon composition thereof, either by default (for example in terms of a predefined number of days in advance compared to the expected reply date), or defined by the message sender; the MUA of the recipient will use the target date as a time marker for generating alert for the recipient that a reply is due in short time.

Also, nothing prevents from applying the present invention to cases in which a message is sent to two or more recipients, from all of which a reply is expected to be received. For example, as replies are received, the addresses of those recipients from which the replies having been received are removed from the message stored in the Reply awaiting folder, so that the reminder messages are sent only to those recipients that have not yet replied.

The action of automatically alerting at least one among the sender of the original message, and the recipient thereof, when the target day for the expected reply comes or approaches may alternatively, or in addition include issuing an alert to the sender of the original message, who is thus made aware of the fact that no reply has yet been received, and may accordingly take the desired action (like for example sending a reminder message, or contacting the recipient by phone, or the like, or even disregard the alert).

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of the present description, a computer-usable or computer-readable medium can be any apparatus, device or element that can contain, store, communicate, propagate, or transport the program for use by or in connection with the computer or instruction execution system.

The medium can be an electronic, magnetic, optical, electromagnetic, infrared, or semiconductor storage medium, network or propagation medium. Examples of a storage medium include a semiconductor memory, fixed storage disk, moveable floppy disk, magnetic tape, and an optical disk. Current examples of optical disks include compact disk-read only memory (CD-ROM), compact disk-read/write (CD-R/W) and digital versatile disk (DVD). Examples of a propagation medium include wires, optical fibers, and wireless transmission.

The invention can be applied in a data processing system having a different architecture or based on equivalent elements; each computer can have another structure or it can be replaced with any data processing entity (such as a PDA, a mobile phone, and the like).

1. An electronic mailing method comprising:
upon sending an electronic mail message to a recipient, activating an automatic monitoring of the receipt of a reply message to the sent message, said automatic monitoring comprising:
ascertaining whether the reply to the message has been received, and
in the negative case, automatically alerting at least one among a sender of the message and the recipient of the message.

2. The method according to claim 1, wherein said automatically alerting includes automatically sending a reminder message to the recipient of the message, said reminder message being adapted to remind the recipient to send the expected reply message.

3. The method according to claim 2, wherein said activating the automatic monitoring comprises including in the message at least one message attribute adapted to indicate that the message is to be submitted to the automatic monitoring of the receipt of the reply message.

4. The method according to claim 1, in which said ascertaining includes:
setting an expected reply date by which the reply messages is expected to be received;
comparing a current date with the expected reply date, and
in case the current date is closer to the expected reply date of more than a predetermined amount of time, performing said alerting.

5. The method according to claim 1, wherein said ascertaining is performed periodically.

6. The method according to claim 1, wherein said alerting is performed at least once.

7. The method according to claim 4, wherein said setting an expected reply date comprises:
during a composition of the message, adding a message attribute indicating the expected reply date.

8. The method according to claim 7, wherein said setting an expected reply date further includes:
during a composition of the message, adding a message attribute indicating an alert start date, said alert start date corresponding to said predetermined amount of time.

9. The method according to claim 8, wherein said setting an expected reply date further comprises:
during a composition of the message, adding a message attribute indicating an alert repetition time.

10. The method according to claim 9, further comprising:
during a composition of the message, adding a message attribute indicating a maximum number of alerts.

11. The method according to claim 1, further comprising:
including in the message a unique message identifier; and
ascertaining that a received message is the expected reply message by checking for the presence, in the received reply message, of the unique message identifier.

12. A data processing system comprising:
means activating an automatic monitoring of the receipt of a reply message to a message being;
means for ascertaining whether the reply to the message has been received, and
means for automatically alerting at least one among a sender of the message and the recipient of the message in case no reply is received.

12. (canceled)

13. A computer product program in a computer readable medium comprising instructions for carrying out the steps of the method, comprising:
upon sending an electronic mail message to a recipient, activating an automatic monitoring of the receipt of a reply message to the sent message,
ascertaining whether the reply to the message has been received, and
in the negative case, automatically alerting at least one among a sender of the message and the recipient of the message;
when said computer program is executed on a computer.
